(19) United States
(12) Patent Application Publication
(10) Pub. No.: US 2021/0312825 A1
(43) Pub. Date: Oct. 7, 2021

(54) ENGLISH DIAGNOSIS ASSESSMENT SYSTEM AND METHOD

(71) Applicant: Wolf International Education Co., Ltd., Huwei Township (TW)

(72) Inventors: ER-FU WU, Huwei Township (TW); HUNG-CHAN CHIU, Huwei Township (TW)

(21) Appl. No.: 17/219,259

(22) Filed: Mar. 31, 2021

(30) Foreign Application Priority Data
Apr. 1, 2020 (TW) 109111379
Apr. 1, 2020 (TW) 109203895

(51) Int. Cl. G09B 7/00; G06Q 10/06; G06Q 50/20; G06F 16/22; G06F 16/2458; G09B 19/06; G06F 40/279

(52) U.S. Cl. CPC G09B 7/00; G06Q 10/06398; G06Q 50/205; G06F 40/279; G06F 16/2462; G09B 19/06; G06F 16/22

(57) ABSTRACT

An English diagnosis assessment system and method are provided to improve English study results. The system includes a server host, an ability indicator database, a test item database, a testing module, a test result database, a test taker analysis module, and a teacher analysis module. The ability indicator database includes at least one test taker ability indicator and at least one teacher ability indicator. The test item database includes plural test items and their correct answers. Each test item corresponds to at least one test taker ability indicator and at least one teacher ability indicator. The test taker analysis module converts and compares the test results of at least two test takers to produce a qualitative analysis result for each test taker. The teacher analysis module converts and compares the test results of test takers taught by at least two teachers to produce a qualitative analysis result for each teacher.

### BACKGROUND OF THE INVENTION

### 1. Technical Field

The present invention relates to an information system and method for educational use. More particularly, the invention relates to an English diagnosis assessment system and method.

### 2. Description of Related Art

The English language is the most widely used language in the world. Given the trend of internationalization, the teaching and learning of English has long been the core subject in cultivating foreign language abilities. Recently, the government of Taiwan has set a goal of becoming a bilingual country by 2030. The Ministry of Education, therefore, mandated that elementary school students have to start study English in the third grade. Local governments went one step further from the Ministry of Education and advanced the elementary school English courses from the third grade to the first grade. Now that more and more importance is attached to the English language ability, it is critical that how to assess the English study results so that students and teachers can keep improving themselves during their learning/teaching process. To measure such progress, an objective and comprehensive evaluation system must be implemented. While numerous widely accepted standardized language examinations currently exist, a majority of these evaluation systems focus primarily on whether the test taker meets the standards solely through quantitive analysis, providing insufficient data beyond scores and results.

For example, prior techniques related to English study assessment have been disclosed in the following patent publications. Taiwan Invention Patent No. 521219, entitled “ENGLISH TESTING AND SCORE ASSESSMENT METHOD AND SYSTEM”, utilizes a control unit to produce test items and their correct answers by retrieving data from a course database in a random number-based manner, to compare a test taker's answers with the correct answers, and to produce a test score accordingly. Taiwan Published Invention Patent Application No. 200511158, entitled “ENGLISH DIAGNOSIS AND TESTING SYSTEM”, produces a practicing and testing effect by hiding certain contents of the test items and allowing a test taker to input the hidden contents for practice. Taiwan Invention Patent No. 1393088, entitled “ENGLISH LEVEL DETERMINATION METHOD”, employs an item bank module, a testing module, and an analysis module so that a test taker can adjust the level of difficulty of the test taken and thereby understand their English level in various aspects.

The afore-cited English diagnosis assessment-related prior techniques, however, are focused on testing, and assessing the scores of individual test takers and fail to provide suitable learning suggestions to the test takers or suitable teaching suggestions to the test takers' teachers as a way to improve the learning or teaching results. Therefore, an English diagnosis assessment system and method aiming to assist educators in understanding the individual weakness and needs of each evaluated student through qualitative analysis, in order to design a comprehensive and customized language learning solution for each student, class, and institution is required.

### BRIEF SUMMARY OF THE INVENTION

In light of the above, one objective of the present invention is to provide an English diagnosis assessment system and method by which a test taker's test result can be converted into a qualitative analysis result for the test taker, and by which the scores of an entire class taught by the same English teacher can be converted into a qualitative analysis result for the teacher, in order to enable improvement in both teaching and learning to obtain a better English study results.

To achieve the foregoing objective, the present invention provides an English diagnosis assessment system that includes a server host, an ability indicator database, a test item database, a testing module, a test result database, a test taker analysis module, and a teacher analysis module. The ability indicator database is created in the server host and includes at least one test taker ability indicator and at least one teacher ability indicator. The test item database is created in the server host and includes a plurality of test items and their respective correct answers, wherein each test item corresponds to at least one test taker ability indicator and at least one teacher ability indicator. The testing module selects a plurality of test items from the test item database to form a test so that a test taker taught by a teacher can take the test to produce a test result. The test result database is created in the server host in order to store a plurality of test results. The test taker analysis module converts and performs a statistical analysis based on the correct/incorrect answer determination results of the test items in the test results of at least two test takers according to the at least one test taker ability indicator to which each of the test items corresponds. After that, the test taker analysis module compares and thereby finds the differences between the at least two test takers' values of the test taker ability indicators to produce a qualitative analysis result for each test taker. The teacher analysis module selects at least two teachers and a plurality of test takers taught by the at least two teachers; and converts and performs a statistical analysis based on the correct/incorrect answer determination results of the test items in the test results of the test takers taught by the at least two teachers, according to the at least one teacher ability indicator to which each of the test items corresponds. After that, the teacher analysis module compares and finds the differences between the at least two teachers' values of the teacher ability indicators to produce a qualitative analysis result for each teacher.

To achieve the foregoing objective, the present invention also provides an English diagnosis assessment method that includes the following steps: (a) An ability indicator database is created, wherein the ability indicator database includes at least one test taker ability indicator and at least one teacher ability indicator. (b) A test item database is created, wherein the test item database includes a plurality of test items and their respective correct answers, each test item corresponding to at least one test taker ability indicator and at least one teacher ability indicator. (c) A plurality of test items are selected from the test item database to form a test so that a test taker taught by a teacher can take the test to produce a test result. (d) A test result database is created to store a plurality of test results. (e) The correct/incorrect answer determination results of the test items in the test result of each test taker are converted and subjected to a statistical analysis according to the at least one test taker ability indicator to which each of the test items corresponds, in order to produce a qualitative analysis result for the test taker. (f) At least two teachers and a plurality of test takers taught by the at least two teachers are selected. The correct/incorrect answer determination results of the test items in the test results of the test takers taught by the at least two teachers are converted and subjected to a statistical analysis according to the at least one teacher ability indicator to which each of the test items corresponds. The teachers' values of the teacher ability indicators are then compared to have their differences determined to produce a qualitative analysis result for each teacher.

Through the technical features described above, the technical solution provided by the present invention can turn test takers' test results into customized qualitative analysis results for the test takers through a conversion and comparison process and therefore provide more effective English study suggestions to the test-taking students than by only performing a statistical analysis based on the test scores. Moreover, the test scores of an entire class taught by the same English teacher can be turned into a customized qualitative analysis result for the teacher through a conversion and comparison process, thereby providing the teacher with a useful English teaching experience. Thus, both students and teachers can improve themselves to better the English study results.

### BRIEF DESCRIPTION OF THE SEVERAL VIEWS OF THE DRAWINGS

FIG. 1 is a block diagram of the English diagnosis assessment system according to an embodiment of the present invention;

FIG. 2 is a flowchart of the English diagnosis assessment method according to an embodiment of the invention; and

FIGS. 3, 4, 5A, 5B, and 6 show how an embodiment of the invention is used.

### DETAILED DESCRIPTION OF THE INVENTION

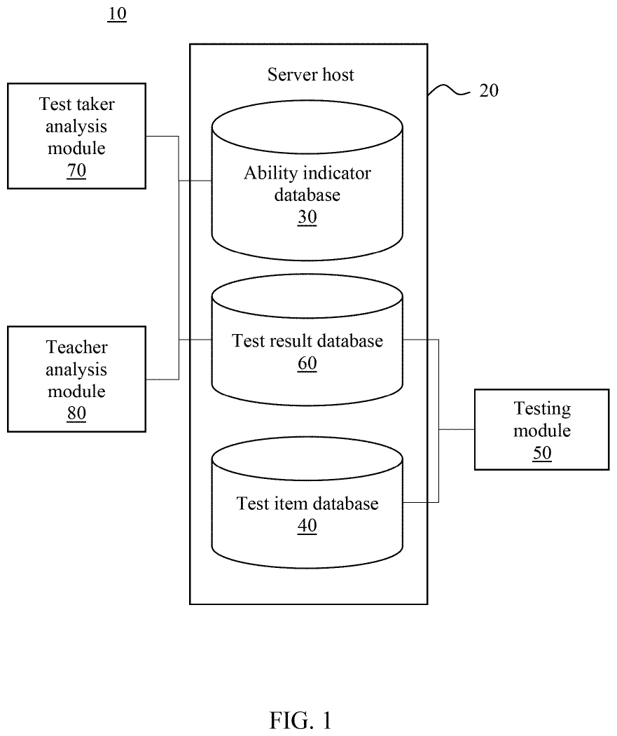

Please refer to FIG. 1 for a block diagram of the English diagnosis assessment system 10 according to an embodiment of the present invention. As shown in FIG. 1, the English diagnosis assessment system 10 includes a server host 20, an ability indicator database 30, a test item database 40, a testing module 50, a test result database 60, a test taker analysis module 70, and a teacher analysis module 80.

The server host 20, in practice, can be a data processing and storage device such as a computer, a calculator, a server, or other calculation devices.

The ability indicator database 30 is created in the server host 20 and includes at least one test taker ability indicator and at least one teacher ability indicator. In practice, the at least one test taker ability indicator can be set according to various English study assessment standards. Taking the twelve-year compulsory education in Taiwan for example, the Ministry of Education specifically defined the multiple stages of learning in the field of the English language, and the anticipated learning performances in each stage of elementary schools, junior high schools, senior high schools, vocational high schools, and comprehensive high schools respectively. So, the corresponding core competency requirements can serve as the basis on it to set and arrange the at least one test taker ability indicator. The scoring criteria of other common English assessment tests such as the ability descriptors of TOEFL Junior, the ability descriptors of TOEFL ITP, the scoring criteria of IELTS, the ability descriptors of TOEIC, and the score descriptions for each level of the General English Proficiency Test in Taiwan may also be used as test taker ability indicators. In practice, the at least one test taker ability indicator can be set by combining or modifying the afore-mentioned indicators. The teacher ability indicator, in practice, is generally obtained by dividing the test taker ability indicator (e.g., a test taker ability indicator is divided into a number of corresponding teacher ability indicators) and may also be set according to the teaching items on a teacher's manual or the items in a teaching evaluation.

The test item database 40 is created in the server host 20 and includes a plurality of test items and a plurality of correct answers corresponding respectively to the test items. Each test item corresponds to at least one test taker ability indicator and at least one teacher ability indicator. In other words, each test item is designed according to at least one test taker ability indicator and at least one teacher ability indicator so that a test item correctly answered by a test taker signifies that the test taker satisfies the test taker ability indicator(s) to which the test item corresponds and that the teacher of the test taker satisfies the teacher ability indicator(s) to which the test item corresponds. In practice, each test item may correspond to only one test taker ability indicator and only one teacher ability indicator, or correspond simultaneously to more than one test taker ability indicator and more than one teacher ability indicator.

In this embodiment of the present invention, the ability indicator database 30 further includes a difficulty level indicator, which includes a high level of difficulty, a medium level of difficulty, and a low level of difficulty. Each test item in the test item database 40 further corresponds to a difficulty level indicator such as a high level of difficulty, a medium level of difficulty, or a low level of difficulty. Moreover, the test items in the test item database 40 can be divided by type into, for example, test items related to listening comprehension, test items related to reading comprehension, test items related to oral expression, and test items related to writing ability.

The testing module 50 is configured to select a plurality of test items from the test item database 40 to form at least one test. At least one test taker taught by a teacher can take the test to produce at least one test result. In practice, the teacher may be a school teacher or a teacher at a cram school, and the test taker may be a student at a common school or a cram school. A test is usually given to and taken simultaneously by a plurality of test takers of the same level, e.g., students of the same grade or in the same class or students in the same class of a cram school, and the test takers may be taught by the same teacher or by several teachers. The term “test result” refers to the answers given by a test taker to the test items in a test.

In this embodiment of the present invention, the testing module 50 has a test item selection rule by which test items are selected according to one or a combination of different parameters such as the at least one test taker ability indicator to which each test item corresponds, the at least one teacher ability indicator to which each test item corresponds, the difficulty level indicator to which each test item corresponds, and the type of each test item.

The test result database 60 is created in the server host 20 and is configured to store a plurality of test results. More specifically, each test result may include one or more of the following pieces of information: a test taker's answers to the test items in a test, the correct/incorrect answer determination results of the test items (i.e., the result of determining as correct or incorrect the answer given by the test taker to each test item), the test taker's personal identification number or name, the personal identification number or name of the teacher teaching the test taker, the test taker's class number, the test taker's grade, and so on.

The test taker analysis module 70 converts and performs a statistical analysis based on the correct/incorrect answer determination results of the test items in the test results of at least two test takers according to the one or more test taker ability indicators to which each test item corresponds. Then, the test taker analysis module 70 compares the at least two test takers' values of the test taker ability indicators to find the differences therebetween and hence produce a qualitative analysis result for each test taker. In other words, the qualitative analysis result for a test taker refers to the result of converting the test taker's test result and thereby determining if the test taker satisfies the test taker ability indicators involved. By comparing the statistical analysis results of the test taker ability indicator values of two or more test takers, the test takers' qualitative analysis results of their current English language abilities can be obtained along with improvement suggestions, and it further assist the test takers to know their respective weaknesses in English language abilities and the areas in which the test takers are advised to make greater efforts in terms of English learning.

The teacher analysis module 80, on the other hand, is configured to analyze teachers' performances. First, a plurality of test takers taught by at least two teachers are selected. Then, the correct/incorrect answer determination results of the test items in the test takers' test results are converted and subjected to a statistical analysis according to the one or more teacher ability indicators to which each test item corresponds. After that, the at least two teachers' values of the teacher ability indicators are compared to find the differences therebetween and thereby produce a qualitative analysis result and a suggestion for each teacher. By converting the test results of multiple test takers taught by the same teacher into a statistical analysis result as to whether or not the teacher satisfies the teacher ability indicators involved, and by comparing two or more teachers' statistical analysis results of the teacher ability indicators involved, the teachers' qualitative analysis results of their English teaching performances can be obtained along with improvement suggestions, and it further assist the teachers to eliminate their respective blind spots in teaching. Moreover, a comparison of the qualitative analysis results of different teachers may encourage an exchange of views between those teachers.

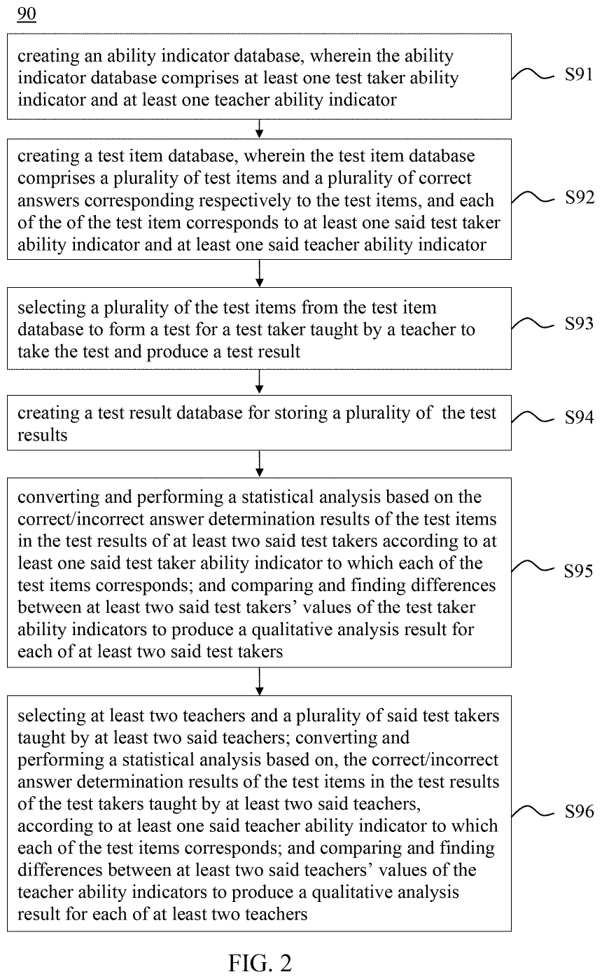

Please refer to FIG. 2 for a flowchart of the English diagnosis assessment method 90 according to an embodiment of the present invention. As shown in FIG. 2, the English diagnosis assessment method 90 includes steps S91 to S96 as detailed below. It should be pointed out that, unless otherwise specified, the order of the steps in this embodiment may be changed; for example, the steps may be carried out simultaneously or partly simultaneously.

In step S91, an ability indicator database is created. The ability indicator database includes at least one test taker ability indicator and at least one teacher ability indicator. In practice, the ability indicator database may be set up in any data processing and storage device such as a computer, a calculator, a server, or other calculation devices. The at least one test taker ability indicator and the at least one teacher ability indicator can be set and adjusted according to various teaching/learning objectives and test types as stated above.

In step S92, a test item database is created. The test item database includes a plurality of test items and their respective correct answers. Each test item corresponds to at least one test taker ability indicator and at least one teacher ability indicator. In practice, each test item may correspond to only one test taker ability indicator and only one teacher ability indicator or correspond simultaneously to more than one test taker ability indicator and more than one teacher ability indicator.

In step S93, a plurality of test items are selected from the test item database to form a test To let a test taker taught by a teacher take the test to produce a test result.

In one embodiment of the present invention, the ability indicator database in step S91 further includes a difficulty level indicator which includes a high level of difficulty, a medium level of difficulty, and a low level of difficulty, and each test item in the test item database in step S92 further corresponds to a difficulty level indicator such as a high level of difficulty, a medium level of difficulty, or a low level of difficulty. Moreover, the test items in the test item database can be divided by type into, for example, test items related to listening comprehension, test items related to reading comprehension, test items related to oral expression, and test items related to writing ability.

In step S94, a test result database is created to store a plurality of test results. Each test result may include one or more of the following pieces of information: a test taker's answers to the test items in a test, the correct/incorrect answer determination results of the test items (i.e., the result of determining as correct or incorrect the answer given by the test taker to each test item), the test taker's personal identification number or name, the personal identification number or name of the teacher teaching the test taker, the test taker's class number, the test taker's grade, and so on.

In step S95, the correct/incorrect answer determination results of the test items in the test results of at least two test takers are converted and subjected to a statistical analysis according to the one or more test taker ability indicators to which each test item corresponds. The at least two test takers' values of the test taker ability indicators are then compared to find the differences therebetween and thereby produce a qualitative analysis result for each test taker.

In step S96, a plurality of test takers taught by at least two teachers are selected. The correct/incorrect answer determination results of the test items in the test takers' test results are converted and subjected to a statistical analysis according to the one or more teacher ability indicators to which each test item corresponds. After that, the at least two teachers' values of the teacher ability indicators are compared to find the differences therebetween and thereby produce a qualitative analysis result for each teacher.

In practice, the ability indicator database, the test item database, and the test result database in steps S91, S92, and S94 can be set up in any data processing and storage device such as a computer, a calculator, a server, or other calculation devices.

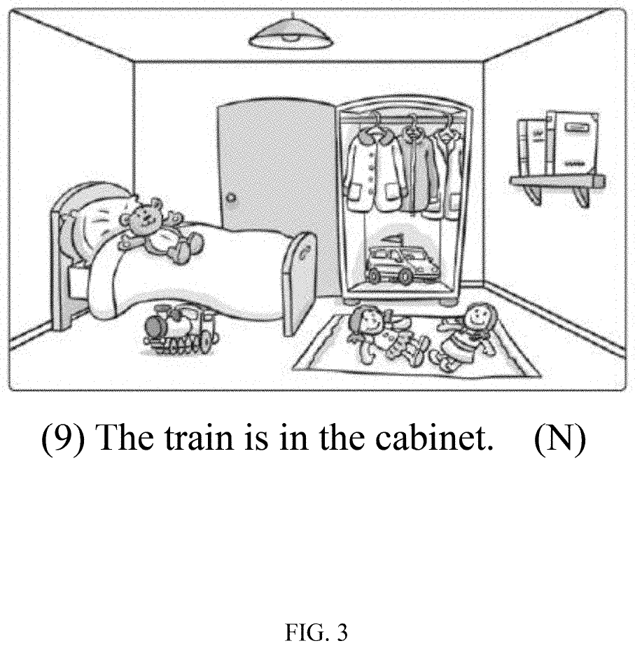

FIG. 3 to FIG. 6 show how an embodiment of the present invention is used, or more particularly the application of the English diagnosis assessment system 10 and the English diagnosis assessment method 90 to fifth-graders' and sixth-graders' English study assessment, including assessment of both students' and teachers' performances.

To begin with, a test is designed to include 65 test items, in which 25 test items are intended to test listening comprehension and 40 test items are intended to test reading comprehension and writing ability. Then, the test taker ability indicators and the teacher ability indicators in the ability indicator database are established as shown in Table 1 and Table 2 below by incorporating certain English diagnosis performance requirements set forth for the twelve-year compulsory education in Taiwan, or more specifically by incorporating some of the diagnosis performance requirements set forth for elementary school students in the third stage of diagnosis in the field of the English language. After that, test items and their respective correct answers are established in the test item database, and the at least one test taker ability indicator and the at least one teacher ability indicator to which each test item corresponds are set. See FIG. 3 for example, the test item that is later selected as test item 9 for testing listening comprehension which shows the picture of the test item along with the statement/question “The train is in the cabinet.” and the correct answer “No” (N) corresponds to the test taker ability indicator “Able to comprehend short sentences by listening” and the teacher ability indicator “Able to comprehend relative positions of objects by listening: in/inside”.

TABLE 1
Test taker ability indicators

| | | |
|---|---|---|
| Type of | Test item | Corresponding test taker |
| test item | no. | ability indicator |

Listening comprehension

| | | |
|---|---|---|
| Part 1: | 1~5 | Able to comprehend daily |
| true/false items | | vocabulary by listening |
| Part 2: | 6~11 | Able to comprehend short |
| true/false items | | sentences by listening |
| Part 3: | 12~18 | Able to comprehend simple daily |
| matching items | | conversations by listening |
| Part 4: | 19~25 | Able to comprehend complicated |
| multiple-choice items | | daily conversations by listening |

Reading comprehension and writing ability

| | | |
|---|---|---|
| Part 1: | 1~10 | Able to comprehend daily |
| true/false items | | vocabulary by reading |
| | 11~20 | Able to comprehend simple |
| | | long sentences by reading |
| Part 2: | 21~25 | Able to comprehend illustrated |
| cloze test | | stories by reading |
| Part 3: | 26~27 | Able to comprehend simple |
| reading comprehension | | articles by reading |
| | 28~30 | Able to comprehend simple written |
| | | communications by reading |
| Part 4: | 31~33 | Able to spell basic |
| cloze test and Q/A in | | daily vocabulary |
| sentence form | 34~36 | Able to write a proper |
| | | response to a question |
| Part 5: | 37~40 | Able to use proper English syntax |
| sentence reorganization | | |

TABLE 2
Teacher ability indicators

| | | |
|---|---|---|
| Type of | Test item | Corresponding teacher |
| test item | no. | ability indicator |

Listening comprehension

| | | | |
|---|---|---|---|
| Part 1: | 1~5 | 1. | Able to comprehend daily vocabulary by |
| true/false items | | | listening: animals |
| | | 2. | Able to comprehend daily vocabulary by |
| | | | listening: toys |
| | | 3. | Able to comprehend daily vocabulary by |
| | | | listening: numbers |
| | | 4. | Able to comprehend daily vocabulary by |
| | | | listening: clothing |
| | | 5. | Able to comprehend comparative sentence |
| | | | patterns by listening |
| Part 2: | 6~11 | 6. | Able to comprehend relative positions of |
| true/false items | | | objects by listening: on/above |
| | | 7. | Able to comprehend relative positions of |
| | | | objects by listening: beside |
| | | 8. | Able to comprehend the quantity of objects by |
| | | | listening |
| | | 9. | Able to comprehend relative positions of |
| | | | objects by listening: in/inside |
| | | 10. | Able to comprehend the presence or absence |
| | | | of an object in a space by listening |
| | | 11. | Able to comprehend the quantity of objects |
| | | | by listening |
| Part 3: | 12~18 | 12. | Able to comprehend school course-related |
| matching items | | | terms by listening |
| | | 13. | Able to comprehend recreation/entertainment- |
| | | | related terms by listening |
| | | 14. | Able to comprehend sports competition- |
| | | | related terms by listening |
| | | 15. | Able to comprehend time-related and eating- |
| | | | related terms by listening |
| | | 16. | Able to comprehend sports-related and school |
| | | | course-related terms by listening |
| | | 17. | Able to comprehend recreational activity- |
| | | | related and outdoor location-related terms by |
| | | | listening |
| | | 18. | Able to comprehend recreational activity- |
| | | | related terms by listening |
| Part 4: | 19~25 | 19. | Able to comprehend the interrogative “why” |
| multiple-choice items | | | and the corresponding reason by listening |
| | | 20. | Able to comprehend the interrogative |
| | | | “where” and the correct location by listening |
| | | 21. | Able to comprehend the interrogative |
| | | | “which” and course-related terms by listening |
| | | 22. | Able to comprehend the interrogative “what” |
| | | | and food names by listening |
| | | 23. | Able to comprehend the interrogative “who” |
| | | | and the terms of address by listening |
| | | 24. | Able to comprehend the interrogative “how” |
| | | | and means of transportation-related terms by |
| | | | listening |
| | | 25. | Able to comprehend the interrogative “when” |
| | | | and the name of each day of the week by |
| | | | listening |

Reading comprehension and writing ability

| | | | |
|---|---|---|---|
| Part 1: | 1~20 | 1. | Able to comprehend daily vocabulary by |
| true/false items | | | reading: food |
| | | 2. | Able to comprehend daily vocabulary by |
| | | | reading: eating utensils |
| | | 3. | Able to comprehend comparative sentence |
| | | | structures by reading |
| | | 4. | Able to comprehend and distinguish gender- |
| | | | related terms of address by reading |
| | | 5. | Able to comprehend daily vocabulary by |
| | | | reading: clothing |
| | | 6. | Able to comprehend profession-related terms |
| | | | of address by reading |
| | | 7. | Able to comprehend daily vocabulary by |
| | | | reading: sports |
| | | 8. | Able to comprehend daily vocabulary by |
| | | | reading: colors |
| | | 9. | Able to comprehend daily vocabulary by |
| | | | reading: dates |
| | | 10. | Able to comprehend daily vocabulary by |
| | | | reading: days of the week |
| | | 11. | Able to comprehend daily vocabulary by |
| | | | reading: sports |
| | | 12. | Able to comprehend daily vocabulary by |
| | | | reading: musical instruments |
| | | 13. | Able to comprehend daily vocabulary by |
| | | | reading: actions |
| | | 14. | Able to comprehend the location of an object |
| | | | by reading |
| | | 15. | Able to comprehend daily vocabulary by |
| | | | reading: actions |
| | | 16. | Able to comprehend the overall scenario of a |
| | | | picture |
| | | 17. | Able to comprehend daily vocabulary by |
| | | | reading: locations |
| | | 18. | Able to comprehend daily vocabulary by |
| | | | reading: actions |
| | | 19. | Able to comprehend daily vocabulary by |
| | | | reading: numbers |
| | | 20. | Able to comprehend daily vocabulary by |
| | | | reading: accessories |
| Part 2: | 21~25 | 21. | Able to use quantifiers properly |
| cloze test | | 22. | Able to use verbs properly |
| | | 23. | Able to distinguish the meanings of different |
| | | | words |
| | | 24. | Able to use gerunds properly |
| | | 25. | Able to determine the meaning of a sentence |
| Part 3: | 26~27 | 26. | Able to comprehend words in an article by |
| reading comprehension | | | reading: health-related terms |
| | | 27. | Able e to comprehend words in an article by |
| | | | reading: health-related terms |
| | 28~30 | 28. | Able to comprehend words in an article by |
| | | | reading: festivity-related terms |
| | | 29. | Able to comprehend words in an article by |
| | | | reading: festivity-related terms |
| | | 30. | Able to comprehend words in an article by |
| | | | reading: festivity-related terms |
| Part 4: | 31~33 | 31. | Able to spell the names of specific locations |
| cloze test and Q/A in | | 32. | Able to spell daily vocabulary: animals. |
| sentence form | | 33. | Able to spell daily vocabulary: pictures |
| | 34~36 | 34. | Able to respond to the interrogative “where” |
| | | | with a location |
| | | 35. | Able to respond to the interrogative “what” |
| | | | with an event |
| | | 36. | Able to respond to the interrogative “what” |
| | | | with an object |
| Part 5: | 37~40 | 37. | Able to form sentences starting with “what |
| sentence reorganization | | | time” |
| | | 38. | Able to form interrogative sentences starting |
| | | | with “can” |
| | | 39. | Able to use the progressive tense properly |
| | | 40. | Able to use the simple past tense properly |

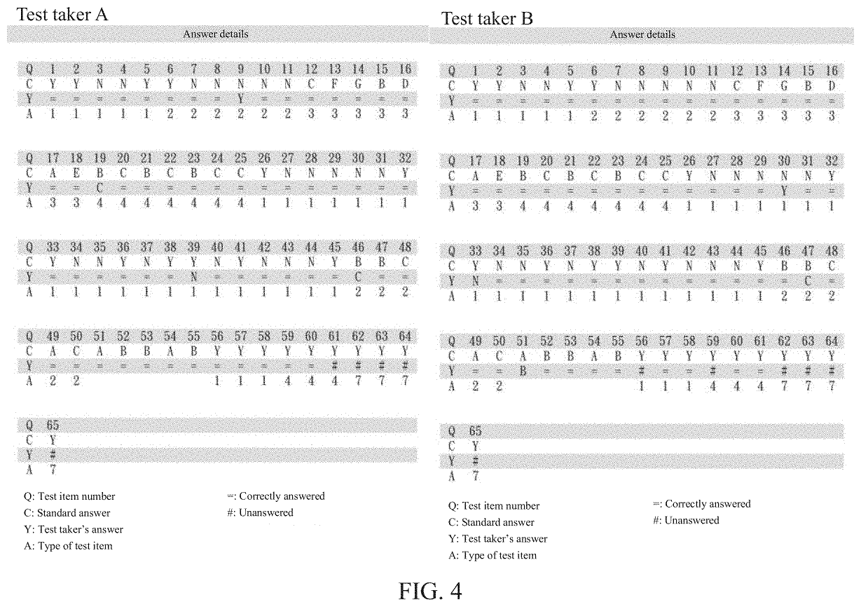

Once the setting is completed, test items are selected from the test item database according to the test item type in the test item selection rule to form the test. The test is given to and taken by test takers A and B, whose test results are shown in FIG. 4.

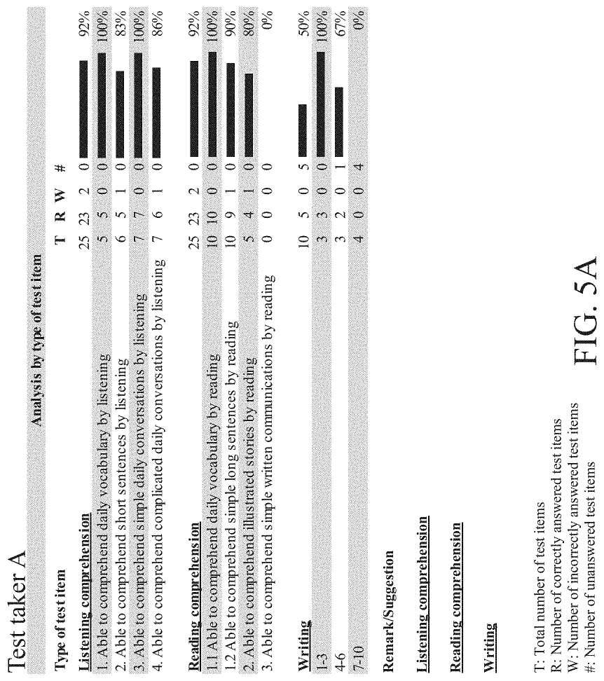

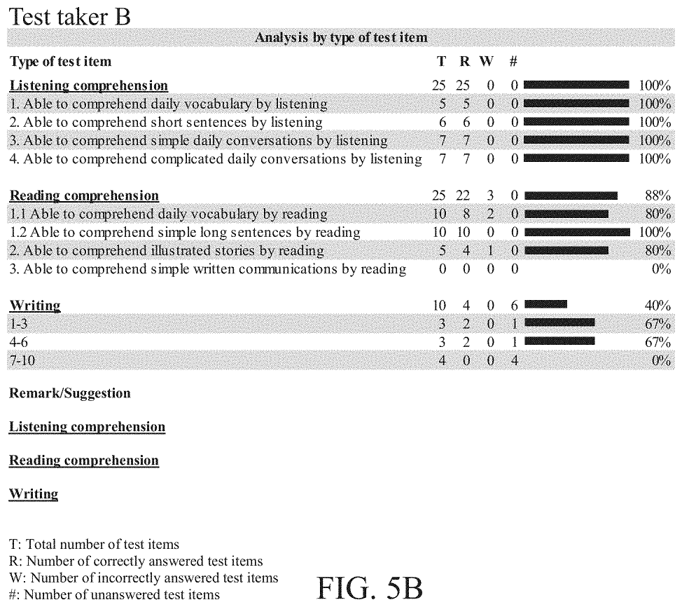

The results in FIG. 4 are converted and subjected to a statistical analysis based on the test taker ability indicators in Table 1, and the resulting values of test takers A and B are compared to produce the two test takers' qualitative analysis results, as shown in FIGS. 5A and 5B, in which the analysis results use concrete qualitative indicators to show test taker A's and test taker B's English listening and reading comprehension abilities. For example, in terms of listening comprehension, test taker A's weakness lies in the inability to completely comprehend short sentences by listening, but test taker B shows no weakness in this regard. In terms of reading comprehension, both test takers A and B find it relatively difficult to comprehend illustrated stories by reading. Suitable English diagnosis suggestions can be derived from the foregoing analyses in order for the test takers to further improve their English language abilities.

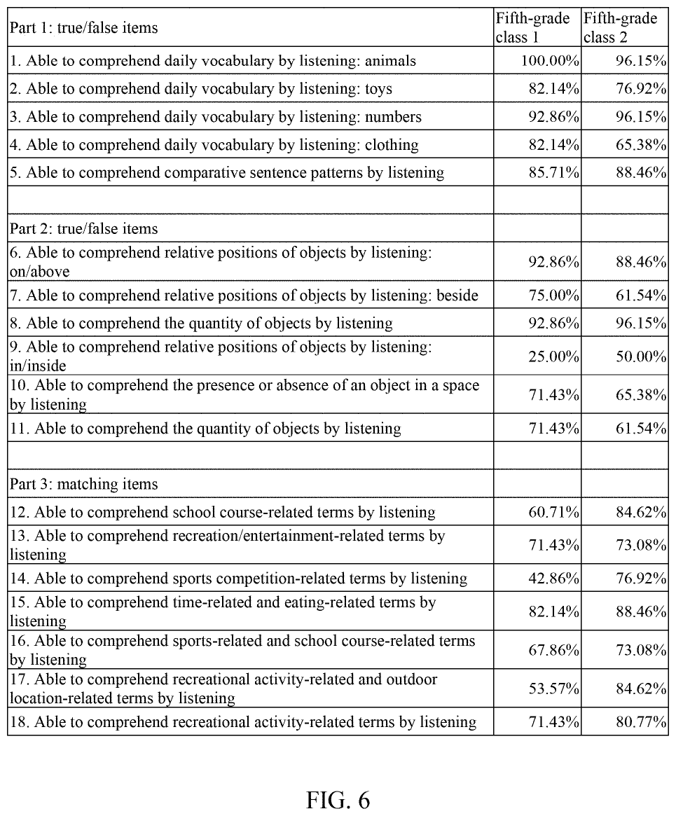

By giving the same test to the students in two classes, who are taught by two different English teachers respectively, and by converting and performing a statistical analysis based on the test takers' test results according to the teacher ability indicators in Table 2 and comparing, and thereby finding the differences between, the teachers' values of the teacher ability indicators, the qualitative analysis results for the teachers are obtained as shown in FIG. 6. The analysis results in FIG. 6 incorporate concrete teacher ability indicators into the test scores of the two classes in order to show whether the English teachers have conveyed the concepts related to the corresponding English language abilities to their students during the teaching process. For example, the students in fifth-grade class 1 perform considerably worse than the students in fifth-grade class 2 with regard to the indicators “Able to comprehend relative positions of objects by listening: in/inside” and “Able to comprehend sports competition-related terms by listening”. In this case, the English teacher of fifth-grade class 1 may ask the English teacher of fifth-grade class 2 for advice, or the two teachers may exchange their views on how to better the teaching method of the foregoing subjects and thereby improve their students' scores.

It can be known from the above that the technical solution provided by the present invention has obvious advantages over and better effects than the prior art. Instead of merely scoring a test taker's performance in a test, the invention turns the test taker's test result into a customized qualitative analysis result for the test taker through a conversion and comparison process to provide the test taker with a more effective English learning suggestion. The invention can also turn the test results of an entire class taught by the same English teacher into a customized qualitative analysis result for the teacher through a conversion and comparison process to provide the teacher with a useful English teaching experience. Thus, with improvements made on the teacher's side as well as on the students' side, better English study results can be achieved.

It should be pointed out that the embodiment detailed above with reference to the accompanying drawings serves only to expound the technical contents and features of the present invention. A person of ordinary skill in the art who understands the technical contents and features of the invention may make various simple modifications or substitutions or reduce the disclosed components without departing from the spirit of the invention. All such modifications, substitutions, and component reductions shall fall within the scope of the invention.

What is claimed is:

1. An English diagnosis assessment system, comprising:
a server host;
an ability indicator database created in the server host, wherein the ability indicator database comprises at least one test taker ability indicator and at least one teacher ability indicator;
a test item database created in the server host, wherein the test item database comprises a plurality of test items and a plurality of correct answers corresponding respectively to the test items, and each of the test item corresponds to at least one said test taker ability indicator and at least one said teacher ability indicator;
a testing module for selecting a plurality of the test items from the test item database to form a test for a test taker taught by a teacher to take the test and thereby produce a test result;
a test result database created in the server host and configured to store a plurality of said test results;
a test taker analysis module for converting, and performing a statistical analysis based on the correct/incorrect answer determination results of the test items in the test results of at least two said test takers according to at least one said test taker ability indicator to which each of the test items corresponds; and for comparing and finding differences between the at least two test takers' values of the test taker ability indicators to produce a qualitative analysis result for each of at least two said test takers; and
a teacher analysis module for selecting at least two teachers and a plurality of said test takers taught by at least two said teachers; and for converting and performing a statistical analysis based on, the correct/incorrect answer determination results of the test items in the test results of the test takers taught by the at least two said teachers, according to at least one said teacher ability indicator to which each of the test items corresponds; and for comparing and finding differences between at least two said teachers' values of the teacher ability indicators to produce a qualitative analysis result for each of at least two said teachers.

2. The English diagnosis assessment system of claim 1, wherein each of the test item in the test item database further corresponds to a difficulty level indicator.

3. The English diagnosis assessment system of claim 1, wherein the test items in the test item database are divisible into the test items related to listening comprehension, the test items related to reading comprehension, the test items related to oral expression, and the test items related to writing ability.

4. The English diagnosis assessment system of claim 1, wherein the testing module further has a test item selection rule is to select a plurality of the test items according to one or a combination of parameters selected from the group consisting of: the at least one test taker ability indicator to which each of the test item corresponds, the at least one teacher ability indicator to which of the test item corresponds, a difficulty level indicator to which each of the test item corresponds, and a type of each of the test item.

5. The English diagnosis assessment system of claim 1, wherein each said test result comprises one or more pieces of information selected from the group consisting of: a said test taker's answers to the test items in a test taken by the test taker, the correct/incorrect answer determination results of the test items, a personal identification number of the test taker, a personal identification name of the test taker, a personal number of the test taker's teacher, a personal name of the test taker's teacher, a class number of the test taker, and a grade of the test taker.

6. An English diagnosis assessment method, comprising the steps of:
(a) creating an ability indicator database, wherein the ability indicator database comprises at least one test taker ability indicator and at least one teacher ability indicator;
(b) creating a test item database, wherein the test item database comprises a plurality of test items and a plurality of correct answers corresponding respectively to the test items, and each of the test item corresponds to at least one said test taker ability indicator and at least one said teacher ability indicator;
(c) selecting a plurality of the test items from the test item database to form a test for a test taker taught by a teacher to take the test and produce a test result;
(d) creating a test result database for storing a plurality of the test results;
(e) converting and performing a statistical analysis based on the correct/incorrect answer determination results of the test items in the test results of at least two said test takers according to at least one said test taker ability indicator to which each of the test items corresponds; and comparing and finding differences between at least two said test takers' values of the test taker ability indicators to produce a qualitative analysis result for each of at least two said test takers; and
(f) selecting at least two teachers and a plurality of said test takers taught by at least two said teachers; converting and performing a statistical analysis based on, the correct/incorrect answer determination results of the test items in the test results of the test takers taught by at least two said teachers, according to at least one said teacher ability indicator to which each of the test items corresponds; and comparing and finding differences between at least two said teachers' values of the teacher ability indicators to produce a qualitative analysis result for each of at least two teachers.

7. The English diagnosis assessment method of claim 6, wherein each of the test item in the test item database in step (b) further corresponds to a difficulty level indicator.

8. The English diagnosis assessment method of claim 6, wherein the test items in the test item database in step (b) are divisible into the test items related to listening comprehension, the test items related to reading comprehension, the test items related to oral expression, and the test items related to writing ability.

9. The English diagnosis assessment method of claim 6, wherein step (c) comprises selecting a plurality of the test items according to one or a combination of parameters selected from the group consisting of: at least one said test taker ability indicator to which each of the test item corresponds, at least one said teacher ability indicator to which each of the test item corresponds, a difficulty level indicator to which each of the test item corresponds, and a type of each of the test item.

10. The English diagnosis assessment method of claim 6, wherein the test result in step (c) comprises one or more pieces of information selected from the group consisting of: the test taker's answers to the test items in the test, the correct/incorrect answer determination results of the test items, a personal identification number of the test taker, a personal identification name of the test taker, a personal number of the test taker's teacher, a personal name of the test taker's teacher, a class number of the test taker, and a grade of the test taker.
